(19) United States
(12) Patent Application Publication
(10) Pub. No.: US 2025/0166238 A1
(43) Pub. Date: May 22, 2025

(54) FINE-LEVEL TEXT CONTROL FOR IMAGE GENERATION

(71) Applicant: SAMSUNG ELECTRONICS CO., LTD., Suwon-si (KR)

(72) Inventors: Hong Suk CHOI, Jersey City, NJ (US); Isaac KASAHARA, Brooklyn, NY (US); Kazim Selim ENGIN, Weehawken, NJ (US); Moritz Alexander GRAULE, New York, NY (US); Nikhil Narsingh CHAVAN DAFLE, Jersey City, NJ (US); Ibrahim Volkan ISLER, Saint Paul, MN (US)

(73) Assignee: SAMSUNG ELECTRONICS CO., LTD., Suwon-si (KR)

(21) Appl. No.: 18/614,405

(22) Filed: Mar. 22, 2024

Related U.S. Application Data
(60) Provisional application No. 63/600,563, filed on Nov. 17, 2023.

(51) Int. Cl. G06T 11/00; G06F 40/205; G06T 5/60; G06T 5/70

(52) U.S. Cl. CPC G06T 11/00; G06T 5/60; G06T 5/70; G06F 40/205; G06T 2207/20081

(57) ABSTRACT

A method includes obtaining a geometric identifier for a target image; obtaining a description of a scene of the target image; parsing the geometric identifier and the description of the scene to obtain a plurality of instances; for each instance, obtaining a two-dimensional skeleton map, an occupancy map, a copied noise image, and a prompt specific to the instance; obtaining an intermediate image based on the two-dimensional skeleton map, the occupancy map, the copied noise image, and the prompt specific to the instance; denoising the intermediate image; generating the target image based on the denoised intermediate image; and controlling a display to output the generated target image.

### CROSS-REFERENCE TO RELATED APPLICATION

This application claims priority to U.S. provisional application No. 63/600,563 filed on Nov. 17, 2023, the entire contents of which are incorporated herein by reference.

### BACKGROUND

### 1. Field

This disclosure relates to generating and displaying an image with multiple instances based on receiving a text prompt and a geometric constraint for each instance in the image. More particularly, the disclosure relates to generating images that fulfill both geometric constraints (e.g., human poses, edges, sketches, segmentation masks, or other) and high-level text descriptions.

### 2. Related Art

In the related art, text-to-image generators are able to steer the text-driven image generation process with geometric input such as human 2D pose, or edge features. While related art text-to-image generators provide control over the geometric form of the instances in the generated image, the related art lacks the capability to accurately dictate the visual appearance of each instance. The related art may produce a correct result if there is only one instance, e.g., one person. However, with multiple instances, the related art produces an inaccurate result, with incorrect and images blended together.

While text-to-image models can incorporate an input text description at the scene level, according to related art models, the user cannot control the generated image at the object instance level. For example, when prompted to generate a cohesive image with a person of specific visual appearance/identity on the left and a person of a different appearance/identity on the right, these models show two typical failures. Either one of the specified descriptions is assigned to both the persons in the generated image or the generated persons show visual features which appear as interpolation of both the specified descriptions.

### SUMMARY

According to one or more embodiments, a method performed by at least one processor, includes obtaining a geometric identifier for a target image; obtaining a description of a scene of the target image; parsing the geometric identifier and the description of the scene to obtain a plurality of instances; for each instance, obtaining a two-dimensional skeleton map, an occupancy map, a copied noise image, and a prompt specific to the instance; obtaining an intermediate image based on the two-dimensional skeleton map, the occupancy map, the copied noise image, and the prompt specific to the instance; denoising the intermediate image; generating the target image based on the denoised intermediate image; and controlling a display to output the generated target image.

According to one or more embodiments, an electronic device including: a display; a memory configured to store instructions; and at least one processor configured to execute the instructions to cause the electronic device to: obtain a geometric identifier for a target image; obtain a description of a scene of the target image; parse the geometric identifier and the description of the scene to obtain a plurality of instances; for each instance, obtain a two-dimensional skeleton map, an occupancy map, a copied noise image, and a prompt specific to the instance; obtain an intermediate image based on the two-dimensional skeleton map, the occupancy map, the copied noise image, and the prompt specific to the instance; denoise the intermediate image; generate the target image based on the denoised intermediate image; and control the display to output the generated target image.

According to one or more embodiments, a non-transitory computer readable medium having instructions stored therein, which when executed by a processor cause the processor to execute a method including: obtaining a geometric identifier for a target image; obtaining a description of a scene of the target image; parsing the geometric identifier and the description of the scene to obtain a plurality of instances; for each instance, obtaining a two-dimensional skeleton map, an occupancy map, a copied noise image, and a prompt specific to the instance; obtaining an intermediate image based on the two-dimensional skeleton map, the occupancy map, the copied noise image, and the prompt specific to the instance; denoising the intermediate image; generating the target image based on the denoised intermediate image; and controlling a display to output the generated target image.

### BRIEF DESCRIPTION OF DRAWINGS

Further features, the nature, and various aspects of the disclosed subject matter will be more apparent from the following detailed description and the accompanying drawings in which:

FIG. 1 is a block diagram of example components of one or more devices, in accordance with embodiments of the present disclosure;

FIGS. 2A and 2B illustrate example inputs and outputs, according to an embodiment;

FIG. 3 illustrates a pipeline of a fine control model, according to an embodiment;

FIG. 4 illustrates an example composition of latent embeddings, according to an embodiment;

FIG. 5 illustrates an example method of generating an image, according to an embodiment;

FIG. 6 illustrates an example method of generating an image, according to an embodiment; and

FIG. 7 illustrates an example method of generating an image, according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, aspects, and characteristics of the present disclosure may be combined in any suitable manner in one or more embodiments. One skilled in the relevant art will recognize, in light of the description herein, that the present disclosure may be practiced without one or more of the specific features or aspects of a particular embodiment. In other instances, additional features and aspects may be recognized in certain embodiments that may not be present in all embodiments of the present disclosure.

According to one or more embodiments, images may be generated that are conditioned on text that describes characteristics and details of instances and background. Text-to-image generators enable finer grained spatial control (i.e., pixel-level specification) of these text-to-image models without re-training the large diffusion models on task-specific training data. It preserves the quality and capabilities of the large production-ready models by injecting a condition embedding from a separately trained encoder into the frozen large models.

According to one or more embodiments, fine control model generates images capable of adhering to the user specified identities, characteristics, and setting, all while adhering to the spatial pose conditioning. Previous methods may merge or ignore parts of longer prompts.

As discussed in this disclosure, fine control model can enable instance-level text conditioning, along with the finer grained spatial control (e.g. human pose). In one embodiment, the method is used in the context of generating images with human poses as control input. However, the method is not limited to this control input.

Given a list of paired human poses and appearance/identity prompts for each human instance, according to an embodiment, the method generates cohesive scenes with humans with distinct text-specified identities in specific poses. The pairing of appearance prompts and the human poses is feasible via large language models (LLMs) or direct instance-specific input from the user. Then, the paired prompts and poses are fed to a network that spatially aligns the instance-level text prompts to the poses in latent space.

According to one or more embodiments, a fine control model provides fine control over each instance's appearance while maintaining the precise pose control capability. One or more embodiments develop and demonstrate fine control with geometric control via human pose images and appearance control via instance-level text prompts. The spatial alignment of instance-specific text prompts and 2D poses in latent space enables the fine control capabilities of fine control. The performance of fine control model improves when compared with related art pose-conditioned text-to-image diffusion models. According to one or more embodiments, the fine control model achieves superior performance in generating images that follow the user-provided instance-specific text prompts and poses, compared to related art methods.

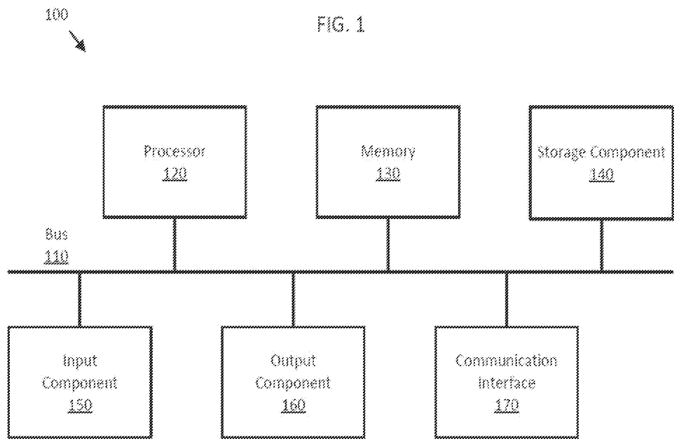

FIG. 1 is a block diagram of example components of one or more devices, according to an embodiment. The device 100 may correspond to a user device, a TV, a wall panel, etc. As shown in FIG. 1, the device 100 may include a bus 110, a processor 120, a memory 130, a storage component 140, an input component 150, an output component 160, and a communication interface 170.

The device 100 may be a smart phone, tablet, laptop, personal computer, etc. For example, embodiments may include a smart phone capable of image generation for art, communications, or marketing with precise control over human poses, appearances, and object placement (i.e., products being marketed). This may be useful for product renderings/arrangements with fine-grained localized control of object layout, setting, background, color scheme, lighting, and ‘mood’; storyboarding for directors and animators; and may be used in animation and in the production and editing of movies and other digital media. One or more embodiments may also be used as a submodule in a multi-modal generative artificial intelligence (AI) assistant that can respond to the user with both text and images. In this setting, a language model submodule may be used to automate the assignment of prompts to different regions or object instances in the image.

The device 100 may be smart glasses, and/or augmented and virtual reality (AR/VR) headsets (having a camera). Applications in AR/VR may be used to modify the appearance of people and environments with fine-grained control over the appearance of each instance while also staying true to the geometry of objects and poses of humans occurring in the (real) environment, such that important structures in AR/VR align with their real-world counterparts. This can be used in virtual wardrobes and dressing rooms; for virtual apartment and house design, decoration, and furniture selection; and in AR/VR worker instructions or video games.

The device 100 may include personal computers, local or cloud-based computing clusters, and data servers. One or more embodiments may include structurally consistent data augmentation for the training of Generative AI and other deep learning models. One or more embodiments may include the training of deep learning models that rely on structural information for their prediction. When training these models, the structure of certain instances should be maintained (for example, the pose of one or multiple humans in the image) while changing their appearance to diversify/augment the training data. In one such example, a method for augmentation in training a model for image retrieval from an image gallery is based on outfit description. According to an embodiment, fine control can augment deep learning training include pose estimation in fitness apps and industrial settings (for worker safety and occupational health); fitness and health monitoring tools; human activity recognition in smart home and other settings; and the detection of suspicious human activities or human threats. Data augmentation improves prediction accuracy and reduces generalization error (i.e., the drop in performance when deploying the model on real-world data).

The related art methods of data augmentation do not allow for the targeted modification and diversification of appearances at the instance level while maintaining key structural features.

In contrast, according to one or more embodiments, structural features (e.g., human poses, edges, . . . ) are maintained while providing the ability to locally augment appearances (for example, maintaining body pose of humans while diversifying skin colors, body types, or clothing type, style, and color). Leveraging this augmentation during training can boost the performance of the resulting deep learning models, lower their generalization error, and mitigate harmful biases.

The bus 110 includes a component that permits communication among the components of the device 100. The processor 120 is implemented in hardware, firmware, or a combination of hardware and software. The processor 120 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 120 includes one or more processors capable of being programmed to perform a function. The memory 130 includes a random access memory (RAM), a read only memory (ROM), and/or another type of dynamic or static storage device (e.g. a flash memory, a magnetic memory, and/or an optical memory) that stores information and/or instructions for use by the processor 120.

The storage component 140 stores information and/or software related to the operation and use of the device 100. For example, the storage component 140 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 150 includes a component that permits the device 100 to receive information, such as via user input (e.g. a touch screen display, a keyboard, a keypad, a mouse, a button, a switch, and/or a microphone). Additionally, or alternatively, the input component 150 may include a sensor for sensing information (e.g. a global positioning system (GPS) component, an accelerometer, a gyroscope, and/or an actuator). The output component 160 includes a component that provides output information from the device 100 (e.g. a display, a speaker, and/or one or more light-emitting diodes (LEDs)).

The communication interface 170 includes a transceiver-like component (e.g., a transceiver and/or a separate receiver and transmitter) that enables the device 100 to communicate with other devices, such as via a wired connection, a wireless connection, or a combination of wired and wireless connections. The communication interface 170 may permit the device 100 to receive information from another device and/or provide information to another device. For example, the communication interface 170 may include an ethernet interface, an optical interface, a coaxial interface, an infrared interface, a radio frequency (RF) interface, a universal serial bus (USB) interface, a Wi-Fi interface, a cellular network interface, or the like.

The device 100 may perform one or more processes described herein. The device 100 may perform these processes in response to the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 170. When executed, software instructions stored in the memory 130 and/or the storage component 140 may cause the processor 120 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 1 are provided as an example. In practice, the device 100 may include additional components, fewer components, different components, or differently arranged components than those shown in FIG. 1. Additionally, or alternatively, a set of components (e.g. one or more components) of the device 100 may perform one or more functions described as being performed by another set of components of the device 100.

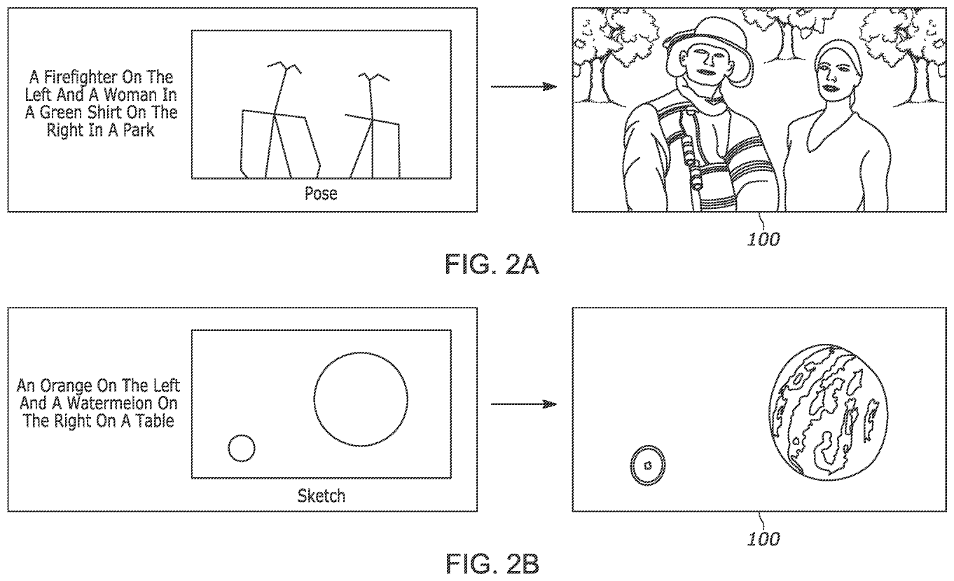

FIGS. 2A and 2B illustrate example inputs and outputs, according to an embodiment. According to an embodiment, a fine control process uses separation and composition of different conditions in a reverse diffusion (e.g., denoising) process. The process includes an end-to-end process and a training-free method that may use the capabilities of a production-ready large diffusion models. In an initial denoising step, a complete noise image is copied by the number of instances. Then, the noise images are denoised by conditioning on separate pairs of text and pose controls in parallel, using the frozen stable diffusion and text-to-image generators. During a series of cross attention operations in stable diffusion's UNet, embeddings are composited using masks generated from the input poses and copied again. This is repeated for every denoising step in the reverse diffusion process. Through this latent space-level separation and composition of multiple conditions, according to one or more embodiments, finely conditioned, both in text and poses, but harmonized images may be generated, as shown in FIGS. 2A and 2B.

For example, according to an embodiment, if the device 100 is provided with a text prompt of “A firefighter on the left and a woman in a green shirt on the right in a park,” and a pose input of two human skeletons, an image at the right of FIG. 2A is generated, according to an embodiment. According to related art methods, the image generated may be inaccurate with identities of the subjects mixed or biased to one of the identities. For example, in related art methods, the image generated may be two firefighters.

According to an embodiment illustrated in FIG. 2B, if the device 100 is provided with a text prompt of “An orange on the left and a watermelon on the right on a table,” and the device 100 is provided a sketch input of two circles of different sizes, then an image at the right of FIG. 2B is generated. According to related art methods, the image generated may be inaccurate with identities of the fruits mixed and/or blended.

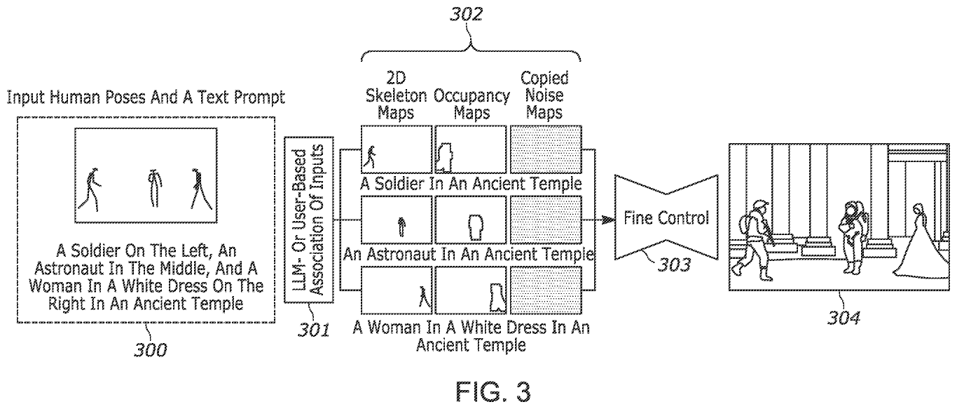

FIG. 3 illustrates a pipeline of a fine control model, according to an embodiment. A fine control process provides users with text and 2D pose control beyond position for individual in-stance (i.e., human) during image generation. Fine control achieves this by spatially aligning different text embeddings with the corresponding instances' 2D poses.

As illustrated at 301 in FIG. 3, given a set of human poses as well as text prompts describing each instance in the image, the prompts and poses may be parsed automatically using LLM and/or based on a user input (301). Then, according to an embodiment, triplets of skeleton/mask/descriptions (302) may be passed to the fine control model 303, and a final image 304 may be generated. By separately conditioning different parts of the image, an accurate representation of the prompt's description of the appearance details, relative location and pose of each person may be produced.

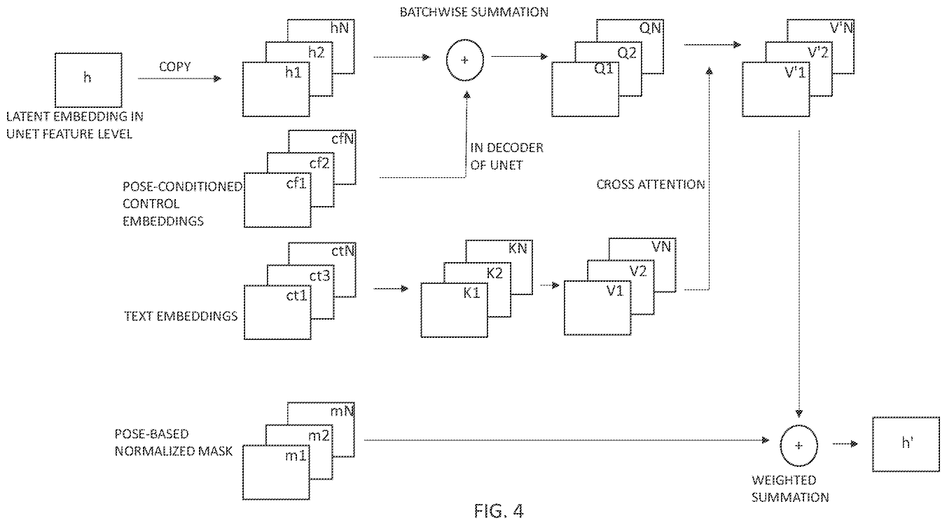

FIG. 4 illustrates an example composition of latent embeddings, according to an embodiment. The composition of latent embeddings may be a training-free method and may perform composition of known and unknown regions of noisy image xₜ.

According to an embodiment, spatial alignment of text and 2D pose may be performed. Although conditional image generation performs reasonably at a global level, it may become challenging when users want fine control over each of multiple instances with text prompts. Because text is not a spatial modality that can be aligned with an image, it is ambiguous to distribute the text embeddings to corresponding desired regions.

According to an embodiment, a process includes spatially aligning instance-level text prompts to corresponding 2D geometry conditions (e.g., 2D poses). Provided with a list of 2D poses {pᵢ^{2d}}₁^{N}, a list of attention masks {mᵢ}₁^{N} is created, where N is the number of instances (e.g., humans or objects). Occupancy maps are extracted from 2D poses and dilated with a kernel size of H/8, where H is the height of the image. The occupancy maps are normalized by Softmax and become attention masks {m}₁^{N}, where sum of mask values add up to 1 at every pixel.

As illustrated in FIG. 4, according to an embodiment, the latent embedding h is defined at each time step which collectively refers to the outputs of UNet cross-attention blocks, as composition of multiple latent embeddings {hᵢ}₁^{N}:

$$h = {\overline{m}}_{1} * {h}_{1} + {\overline{m}}_{2} * {h}_{2} + … + {\overline{m}}_{N} * {h}_{N} \qquad ( Equation 1 )$$

where hᵢ embeds the ith instance's text condition in the encoding step and text and 2D pose conditions in the decoding step, and m̅ᵢ is a resized attention mask. Now, h contains spatially aligned text embeddings of multiple in-stances. The detailed composition process is illustrated in FIG. 4. FIG. 4 graphically depicts how Equation 1 is implemented in a UNet's cross attention layer for text and 2D pose control embeddings. In both encoding and decoding stages of UNet, copied latent embeddings {hᵢ}₁^{N} are conditioned on instance-level text embeddings {cᵢ}₁^{N} by cross attention in parallel. In the decoding stage of UNet, instance-level 2D pose control embeddings {c_{f}}₁^{N} are added to the copied latent embeddings {hᵢ}₁^{N} before the cross attention. σ

The composition in the latent space level is fundamentally more stable for image generation purposes. In each (denoising diffusion implicit models) DDIM step of the reverse diffusion, xₜ₋₁ is conditioned on the predicted x₀ as below:

$${x}_{t - 1} = \sqrt{{α}_{t - 1}} {x}_{0} + \sqrt{1 - {α}_{t - 1} - {σ}_{t}^{2}} \cdot {ϵ}_{θ} ( {x}_{t} ) + {σ}_{t} {ϵ}_{t} \qquad ( Equation 2 )$$

$${x}_{0} = ( \frac{{x}_{t} - \sqrt{1 - {α}_{t}} {ϵ}_{θ} ( {x}_{t} )}{\sqrt{{α}_{t}}} ) \qquad ( Equation 3 )$$

where αₜ is the noise variance at the time step t, sigma adjusts the stochastic property of the forward process, and ϵₜ is standard Gaussian noise independent of xₜ. As shown in Equation 3, compositing multiple noisy images as in inpainting literature is targeting interpolation of multiple denoised images for generation. On the contrary, the latent-level composition mathematically samples a unique solution from a latent embedding that encodes spatially separated text and pose conditions.

Image generation using probabilistic diffusion models is performed by sampling a learned distribution p_{Θ}(x₀) that approximates the real data distribution q(x₀), where θ is learnable parameters of denoising autoencoders ϵ_{Θ}(x₀). During training, the diffusion models gradually add noise to the image x₀ and produce a noisy image xₜ. The time step t is the number of times noise is added and uniformly sampled from {1, . . . , T}. The parameters Θ are optimized to predict the added noise with the objective:

$${L}_{D M} = {𝔼}_{x , ϵ \sim 𝒩 ( 0 , 1 ) , t} [ {‖ ϵ - {ϵ}_{θ} ( {x}_{t} , t ) ‖}_{2}^{2} ] , \qquad ( Equation 4 )$$

where cₜ is a text embedding and c_{f} is a task-specific embedding that is spatially aligned with an image.

In inference time, the sampling (i.e., reverse diffusion) may be approximated by denoising the randomly sampled Gaussian noise xₜ to the image x₀ using the trained network ϵ_{θ}(x).

According to an embodiment, conditional image generation may be performed using modeling conditional distributions as a form of p_{θ}(x₀|c), where c is the conditional embedding that is processed from text or a task-specific modality. According to an embodiment, latent diffusion methods augment a UNet-based denoising autoencoders by applying cross attention between noisy image embedding zₜ and conditional embedding c. The network parameters Θ may be optimized according to Equation 4.

According to an embodiment, fine control is a training-free method that is built upon pre-trained stable diffusion and text-to-image generators. Using a text-to-image generator's pose-to-image model, a reverse diffusion process is applied for fine-level text control of multiple people at inference time. The whole process is run in an end-to-end fashion. According to one or more embodiments, it is not required to do a pre-denoising stage to obtain fixed segmentation of instances as LMD nor inpainting as postprocessing for harmonization. The overall pipeline of fine control model is depicted in FIG. 3.

According to an embodiment, a method includes providing instance level prompts that describe each human. While a user can manually prescribe each instance description to each skeleton (i.e. 2D pose) as easily as writing a global prompt, large language models (LLM) can also be used as a pre-processing step, according to an embodiment. If a user provides a global level description of the image containing descriptions and relative locations for each skeleton, many of the current LLM can take the global prompt and parse it into instance level prompts. Then, given the center points of each human skeleton and the positioning location from the global prompt, an LLM could then assign each instance prompt to the corresponding skeleton. This automates the process and allows for a direct comparison of methods that take in detailed global prompts and methods that take in prompts per skeleton. An example of such processing is included in FIGS. 2A and 2B.

According to an embodiment, users may be provided with harmony parameters in addition to the default parameters of a text-to-image generator. Text-driven fine control of instances may have a moderate trade-off between identity instruction observance of each instance and the overall quality for image generation. For example, if human instances are too close and the resolutions are low, it is more likely to suffer from identity blending as occurs in a related art text-to-image generator. In such examples, users can increase the softmax temperature of attention masks {m}₁^{N}, before normalization. It will lead to better identity observance, but could cause discordant with surrounding pixels or hinder the denoising process due to unexpected discretization error in extreme cases. Alternatively, users can keep the higher softmax temperature for initial DDIM steps and revert it back to a default value. According to an example embodiment, 0.001 may be used as a softmax temperature and argmax may be applied on the dilated pose occupancy maps for the first quarter of the entire DDIM steps.

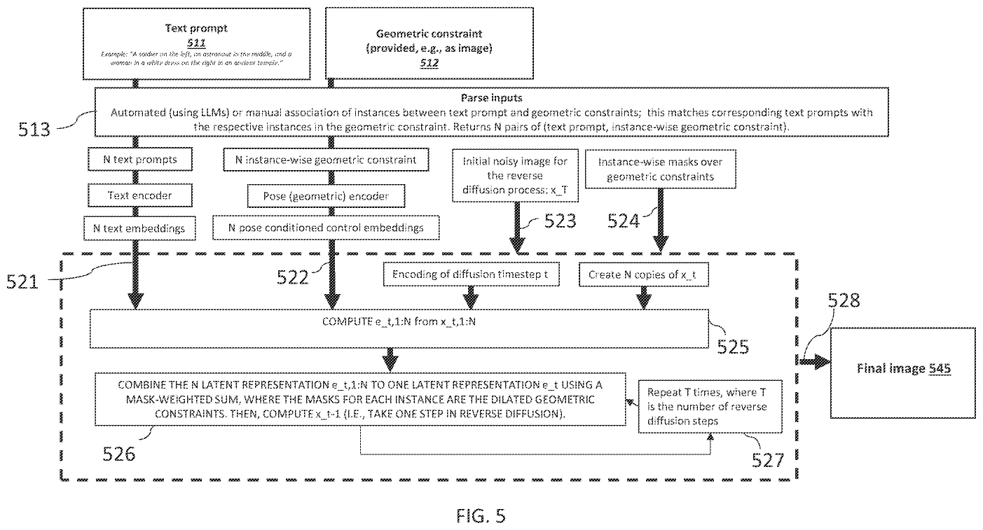

FIG. 5 illustrates an example method of generating an image, according to one or more embodiments. The method may include receiving a text prompt 511 and a geometric constraint 512. As an example, the text prompt may be: “A soldier on the left, an astronaut in the middle, and a woman in a white dress on the right in an ancient temple.” The geometric constraint may be provided as an image. For example, the geometric constraint may be an image with human pose constraints, e.g., skeleton poses. As another example, a geometric constraint may be an image of a sketch input.

At operation 513, the text prompt and geometric constraint inputs may be parsed. For example, the inputs may be parsed automatically (e.g., using LLMs (large language models)) or manually to associate between text prompt and geometric constraints. For example, this matches a text prompt for each instance with a corresponding geometric constraint. An instance may refer to a subject, e.g., a person. For example, the text prompt above contains three instances. Operation 513 returns N pairs of (text prompt, instance-wise geometric constraint). N may refer to the number of instances. The parsing process at operation 513 may be referred to as pre-processing.

At operation 521, according to one or more embodiments, the N text prompts are provided to a text encoder, which produces N text embeddings. For example, for each instance, there is a text prompt provided to a text encoder, producing a text embedding.

At operation 522, according to one or more embodiments, N instance-wise geometric constraints are provided to a pose (e.g., geometric) encoder, which produces N pose-conditioned control embeddings.

At operation 523, an initial noisy image is generated for the reverse diffusion process x_T (e.g., x_{T}), which is an initialization process.

At operation 524, an instance-wise mask is generated for each instance. In analyzing the masks, the most emphasis is placed on the white area, a medium emphasis is placed on the gray area, and the least emphasis is placed on the black area. For example, according to FIG. 5, the white area on the left corresponds to the instance of the soldier on the left.

At operation 525, the N text embeddings, N pose-conditioned control embeddings are combined with encoding of diffusion timestep t and N copies of x_t (e.g., xₜ). Further at operation 525, e_t (e.g., ϵₜ) is computed for each instance. For example, in the above example with three instances, ϵₜ is computed three times. Further ϵₜ is computed from xₜ, where ϵₜ is standard Gaussian noise independent of xₜ.

At operation 526, the method includes combining the N latent representation e_t,1: n to one latent representation e_t using a mask-weighted sum, where the masks for each instance are the dilated geometric constraints. Then, the method includes determining x_t−1 according to the following (i.e., take one step in reverse diffusion):

$${x}_{t - 1} = \sqrt{{α}_{t - 1}} {x}_{0} + \sqrt{1 - {α}_{t - 1} - {σ}_{t}^{2}} \cdot {ϵ}_{θ} ( {x}_{t} ) + {σ}_{t} {ϵ}_{t} \qquad ( Equation 2 )$$

At operation 527, the method includes repeating operation 526 T times, where T is the number of reverse diffusion steps.

At operation 528, a final image 545 is generated and may be displayed on the display of a device 100. The final image 545 may be similar to final image 304 in FIG. 3.

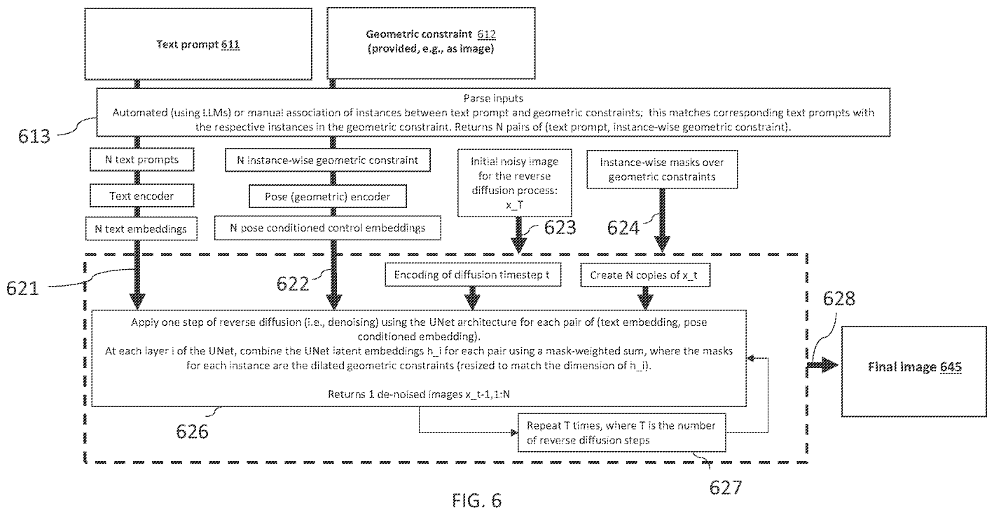

FIG. 6 illustrates an example method of generating an image, according to one or more embodiments. The method may include receiving a text prompt 611 and a geometric constraint 612. As an example, the text prompt may be: “A soldier on the left, an astronaut in the middle, and a woman in a white dress on the right in an ancient temple.” The geometric constraint may be provided as an image. For example, the geometric constraint may be an image with human pose constraints, e.g., skeleton poses. As another example, a geometric constraint may be an image of a sketch input.

At operation 613, the text prompt and geometric constraint inputs may be parsed. For example, the inputs may be parsed automatically (e.g., using LLMs (large language models)) or manually to associate between text prompt and geometric constraints. For example, this matches a text prompt for each instance with a corresponding geometric constraint. An instance may refer to a subject, e.g., a person. For example, the text prompt above contains three instances. Operation 613 returns N pairs of (text prompt, instance-wise geometric constraint). N may refer to the number of instances. The parsing process at operation 613 may be referred to as pre-processing.

At operation 621, according to one or more embodiments, the N text prompts are provided to a text encoder, which produces N text embeddings. For example, for each instance, there is a text prompt provided to a text encoder, producing a text embedding.

At operation 622, according to one or more embodiments, N instance-wise geometric constraints are provided to a pose (e.g., geometric) encoder, which produces N pose-conditioned control embeddings.

At operation 623, an initial noisy image is generated for the reverse diffusion process x_T (e.g., x_{T}), which is an initialization process.

At operation 624, an instance-wise mask is generated for each instance. In analyzing the masks, the most emphasis is placed on the white area, a medium emphasis is placed on the gray area, and the least emphasis is placed on the black area. For example, according to FIG. 6, the white area on the left corresponds to the instance of the soldier on the left.

At operation 626, the method includes applying a step of reverse diffusion (i.e., denoising) using the UNet architecture for each pair N (text embedding, pose conditioned embedding). At each layer i of the UNet, combine the UNet latent embeddings hᵢ for each pair using a mask-weighted sum, where the masks for each instance are the dilated geometric constraints (resized to match the dimension of hᵢ). According to an embodiment, operation 626 returns 1 de-noised images x_t−1,1:N:

$${x}_{t - 1} = \sqrt{{α}_{t - 1}} {x}_{0} + \sqrt{1 - {α}_{t - 1} - {σ}_{t}^{2}} \cdot {ϵ}_{θ} ( {x}_{t} ) + {σ}_{t} {ϵ}_{t} \qquad ( Equation 2 )$$

At operation 627, the method includes repeating operation 626 T times, where T is the number of reverse diffusion steps.

At operation 628, a final image 645 is generated and may be displayed on the display of a device 100. The final image 645 may be similar to final image 304 in FIG. 3.

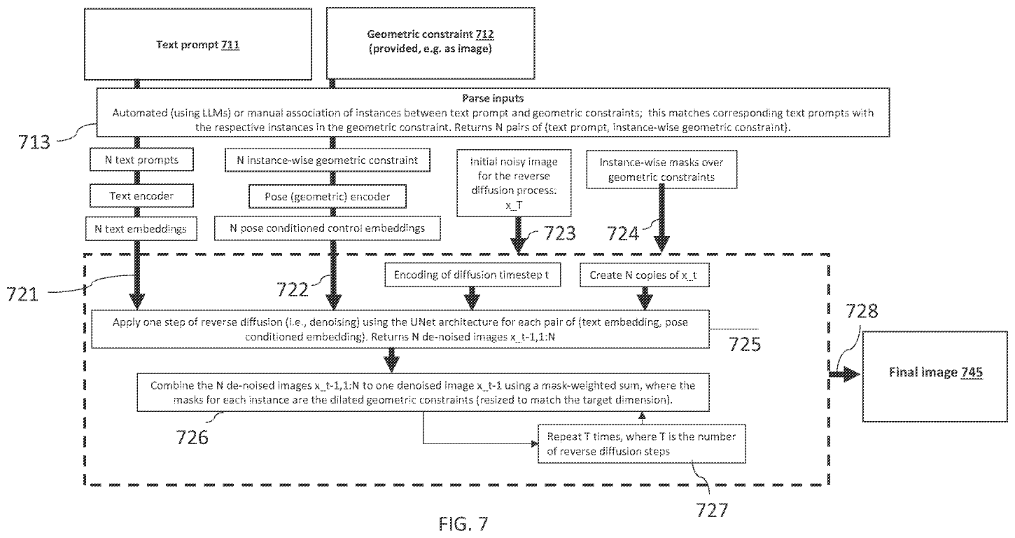

FIG. 7 illustrates an example method of generating an image, according to one or more embodiments. The method may include receiving a text prompt 711 and a geometric constraint 712. As an example, the text prompt may be: “A soldier on the left, an astronaut in the middle, and a woman in a white dress on the right in an ancient temple.” The geometric constraint may be provided as an image. For example, the geometric constraint may be an image with human pose constraints, e.g., skeleton poses. As another example, a geometric constraint may be an image of a sketch input.

At operation 713, the text prompt and geometric constraint inputs may be parsed. For example, the inputs may be parsed automatically (e.g., using LLMs (large language models)) or manually to associate between text prompt and geometric constraints. For example, this matches a text prompt for each instance with a corresponding geometric constraint. An instance may refer to a subject, e.g., a person. For example, the text prompt above contains three instances. Operation 713 returns N pairs of (text prompt, instance-wise geometric constraint). N may refer to the number of instances. The parsing process at operation 713 may be referred to as pre-processing.

At operation 721, according to one or more embodiments, the N text prompts are provided to a text encoder, which produces N text embeddings. For example, for each instance, there is a text prompt provided to a text encoder, producing a text embedding.

At operation 722, according to one or more embodiments, N instance-wise geometric constraints are provided to a pose (e.g., geometric) encoder, which produces N pose-conditioned control embeddings.

At operation 723, an initial noisy image is generated for the reverse diffusion process x_T (e.g., x_{T}), which is an initialization process.

At operation 724, an instance-wise mask is generated for each instance. In analyzing the masks, the most emphasis is placed on the white area, a medium emphasis is placed on the gray area, and the least emphasis is placed on the black area. For example, according to FIG. 7, the white area on the left corresponds to the instance of the soldier on the left.

At operation 725, the method includes applying one step of reverse diffusion (i.e., denoising) using the UNet architecture for each pair of (text embedding, pose conditioned embedding). Operation 725 returns N de-noised images xₜ₋₁,1:N.

At operation 726, the method includes combining the N de-noised images xₜ₋₁, 1:N to one denoised image xₜ₋₁ using a mask-weighted sum, where the masks for each instance are the dilated geometric constraints (resized to match the target dimension).

At operation 727, the method includes repeating operation 726 T times, where T is the number of reverse diffusion steps.

At operation 728, a final image 745 is generated and may be displayed on the display of a device 100. The final image 745 may be similar to final image 304 in FIG. 3.

The embodiments have been described above and illustrated in terms of blocks, as shown in the drawings, which carry out the described function or functions. These blocks may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:
(1) A method, performed by at least one processor of an electronic device, the method comprising: obtaining a geometric identifier for a target image; obtaining a description of a scene of the target image; parsing the geometric identifier and the description of the scene to obtain a plurality of instances; for each instance, obtaining a two-dimensional skeleton map, an occupancy map, a copied noise image, and a prompt specific to the instance; obtaining an intermediate image based on the two-dimensional skeleton map, the occupancy map, the copied noise image, and the prompt specific to the instance; denoising the intermediate image; generating the target image based on the denoised intermediate image; and controlling a display to output the generated target image.
(2) The method according to feature (1), in which the geometric identifier is a pose input.
(3) The method according to feature (1), in which the geometric identifier is a sketch input.
(4) The method according to any one of features (1)-(3), in which the denoising the intermediate image comprises a reverse diffusion process.
(5) The method according to any one of features (1)-(4), in which the reverse diffusion process comprises repeating a diffusion process a predetermined number of times.
(6) The method according to any one of features (1)-(5), in which the denoising the intermediate image comprises: for each denoising step, copying a latent embedding in a Unet feature level; obtaining pose embeddings; and obtaining a batch-wise sum based on the Unet feature level and the pose embeddings.
(7) The method according to any one of features (1)-(6), in which the obtaining the occupancy map comprises dilating the two-dimensional skeleton map.
(8) The method according to any one of features (1)-(7), in which the generating the target image comprises providing the target image in at least one of smart glasses, a mobile application, or fitness tracking apparatus.
(9) The method according to any one of features (1)-(8), further comprising controlling a signal to output the generated target image to at least one of smart glasses, a mobile device, or fitness tracking apparatus.
(10) An electronic device comprising: a display; a memory configured to store instructions; and at least one processor configured to execute the instructions to cause the electronic device to: obtain a geometric identifier for a target image; obtain a description of a scene of the target image; parse the geometric identifier and the description of the scene to obtain a plurality of instances; for each instance, obtain a two-dimensional skeleton map, an occupancy map, a copied noise image, and a prompt specific to the instance; obtain an intermediate image based on the two-dimensional skeleton map, the occupancy map, the copied noise image, and the prompt specific to the instance; denoise the intermediate image; generate the target image based on the denoised intermediate image; and control the display to output the generated target image.
(11) The electronic device according to feature (10), in which the geometric identifier is a pose input.
(12) The electronic device according to feature (10), in which the geometric identifier is a sketch input.
(13) The electronic device according to any one of features (10)-(12), in which the denoising the intermediate image comprises a reverse diffusion process.
(14) The electronic device according to any one of features (10)-(13), in which the reverse diffusion process comprises repeating a diffusion process a predetermined number of times.
(15) The electronic device according to any one of features (10)-(14), in which at least one processor is further configured to execute the instructions to cause the electronic device to: for each denoising step, copy a latent embedding in a Unet feature level; obtain pose embeddings; and obtain a batch-wise sum based on the Unet feature level and the pose embeddings.
(16) The electronic device according to any one of features (10)-(15), in which the at least one processor is further configured to execute the instructions to cause the electronic device to dilate the two-dimensional skeleton map.
(17) The electronic device according to any one of features (10)-(16), in which the at least one processor is further configured to execute the instructions to cause the electronic device to provide the target image in at least one of smart glasses, a mobile application, or fitness tracking apparatus.
(18) The electronic device according to any one of features (10)-(17), in which the at least one processor is further configured to execute the instructions to cause the electronic device to control a signal to output the generated target image to at least one of smart glasses, a mobile device, or fitness tracking apparatus.
(19) A non-transitory computer readable medium having instructions stored therein, which when executed by a processor cause the processor to execute a method comprising: obtaining a geometric identifier for a target image; obtaining a description of a scene of the target image; parsing the geometric identifier and the description of the scene to obtain a plurality of instances; for each instance, obtaining a two-dimensional skeleton map, an occupancy map, a copied noise image, and a prompt specific to the instance; obtaining an intermediate image based on the two-dimensional skeleton map, the occupancy map, the copied noise image, and the prompt specific to the instance; denoising the intermediate image; generating the target image based on the denoised intermediate image; and controlling a display to output the generated target image.
(20) The non-transitory computer readable medium according to feature (19), in which the geometric identifier is a pose input.

What is claimed is:

1. A method, performed by at least one processor of an electronic device, the method comprising:
obtaining a geometric identifier for a target image;
obtaining a description of a scene of the target image;
parsing the geometric identifier and the description of the scene to obtain a plurality of instances;
for each instance, obtaining a two-dimensional skeleton map, an occupancy map, a copied noise image, and a prompt specific to the instance;
obtaining an intermediate image based on the two-dimensional skeleton map, the occupancy map, the copied noise image, and the prompt specific to the instance;
denoising the intermediate image;
generating the target image based on the denoised intermediate image; and
controlling a display to output the generated target image.

2. The method of claim 1, wherein the geometric identifier is a pose input.

3. The method of claim 1, wherein the geometric identifier is a sketch input.

4. The method of claim 1, wherein the denoising the intermediate image comprises a reverse diffusion process.

5. The method of claim 4, wherein the reverse diffusion process comprises repeating a diffusion process a predetermined number of times.

6. The method of claim 1, wherein the denoising the intermediate image comprises:
for each denoising step, copying a latent embedding in a Unet feature level;
obtaining pose embeddings; and
obtaining a batch-wise sum based on the Unet feature level and the pose embeddings.

7. The method of claim 1, wherein the obtaining the occupancy map comprises dilating the two-dimensional skeleton map.

8. The method of claim 1, wherein the generating the target image comprises providing the target image in at least one of smart glasses, a mobile application, or fitness tracking apparatus.

9. The method of claim 1, further comprising controlling a signal to output the generated target image to at least one of smart glasses, a mobile device, or fitness tracking apparatus.

10. An electronic device comprising:
a display;
a memory configured to store instructions; and
at least one processor configured to execute the instructions to cause the electronic device to:
obtain a geometric identifier for a target image;
obtain a description of a scene of the target image;
parse the geometric identifier and the description of the scene to obtain a plurality of instances;
for each instance, obtain a two-dimensional skeleton map, an occupancy map, a copied noise image, and a prompt specific to the instance;
obtain an intermediate image based on the two-dimensional skeleton map, the occupancy map, the copied noise image, and the prompt specific to the instance;
denoise the intermediate image;
generate the target image based on the denoised intermediate image; and
control the display to output the generated target image.

11. The electronic device of claim 10, wherein the geometric identifier is a pose input.

12. The electronic device of claim 10, wherein the geometric identifier is a sketch input.

13. The electronic device of claim 10, wherein the denoising the intermediate image comprises a reverse diffusion process.

14. The electronic device of claim 13, wherein the reverse diffusion process comprises repeating a diffusion process a predetermined number of times.

15. The electronic device of claim 10, wherein the at least one processor is further configured to execute the instructions to cause the electronic device to:
for each denoising step, copy a latent embedding in a Unet feature level;
obtain pose embeddings; and
obtain a batch-wise sum based on the Unet feature level and the pose embeddings.

16. The electronic device of claim 10, wherein the at least one processor is further configured to execute the instructions to cause the electronic device to dilate the two-dimensional skeleton map.

17. The electronic device of claim 10, wherein the at least one processor is further configured to execute the instructions to cause the electronic device to provide the target image in at least one of smart glasses, a mobile application, or fitness tracking apparatus.

18. The electronic device of claim 10, wherein the at least one processor is further configured to execute the instructions to cause the electronic device to control a signal to output the generated target image to at least one of smart glasses, a mobile device, or fitness tracking apparatus.

19. A non-transitory computer readable medium having instructions stored therein, which when executed by a processor cause the processor to execute a method comprising:
obtaining a geometric identifier for a target image;
obtaining a description of a scene of the target image;
parsing the geometric identifier and the description of the scene to obtain a plurality of instances;
for each instance, obtaining a two-dimensional skeleton map, an occupancy map, a copied noise image, and a prompt specific to the instance;
obtaining an intermediate image based on the two-dimensional skeleton map, the occupancy map, the copied noise image, and the prompt specific to the instance;
denoising the intermediate image;
generating the target image based on the denoised intermediate image; and
controlling a display to output the generated target image.

20. The non-transitory computer readable medium of claim 19, wherein the geometric identifier is a pose input.
